(19) United States
(12) Patent Application Publication
(10) Pub. No.: US 2006/0213856 A1
(43) Pub. Date: Sep. 28, 2006

(54) Handled drinking container

(76) Inventors: Stephanie Kraus, Glendale, CA (US); Randal Ouye, La Crescenta, CA (US)

Correspondence Address: THE WALT DISNEY COMPANY;C/O GREENBERG TRAURIG LLP, 2450 COLORADO AVENUE SUITE 400E, SANTA MONICA, CA, 90404, US

(21) Appl. No.: 11/091,973

(22) Filed: Mar. 28, 2005

(51) Int. Cl. A61J 11/00; A61J 9/08; B65D 23/10; A61J 9/00

(52) U.S. Cl. 215/11.1; 215/396; 215/11.6; 215/395

(57) ABSTRACT

A container, such as a baby bottle or sipper cup, includes an elongated side wall and one or more handles to either side of the elongated side wall for facilitating handling of the bottle. There is a rim at the top of the side wall for receiving a nipple locating closure. With two handles, these are diametrically opposite each other with the elongated bottle between them. The handles are formed as an integrated substantially embracive or curved element, and the element has an aperture at one section for engagement with the mounting of the bottle, and the curved element essentially surrounds the bottle. The curved element is removable from the mounting.

### RELATED APPLICATIONS

This application is related to U.S. Utility patent application filed on Mar. 28, 2005, entitled “MULTI-COMPARTMENT DISPENSING CONTAINER” (Docket No. 54317-040701, Express Mail Label No. EV 310 127 888 US); U.S. Utility patent application filed on Mar. 28, 2005, entitled “CLEANING UTENSIL FOR A FLUID CONTAINER” (Docket No. 54317-040702, Express Mail Label No. EV 310 127 891 US); U.S. Utility patent application filed on Mar. 28, 2005, entitled “IRREGULAR SHAPED BABY BOTTLE” (Docket No. 54317-040703, Express Mail Label No. EV 310 128 905 US); and U.S. Utility patent application filed on Mar. 28, 2005, entitled “BABY BOTTLE WITH ENLARGED LOWER PORTION” (Docket No. 54317-040705, Express Mail Label No. EV 310 127 928 US); all of which have been filed concurrently herewith. The contents of those applications are incorporated by reference herein.

### BACKGROUND

1. Field

This disclosure relates to drinking container constructions. More particularly the disclosure relates to an ergonomically designed baby bottle and/or a sipper cup.

2. General Background

There are numerous baby bottles on the market, with different functions and features. None of the known bottles provide the features of the present disclosure. The prior art is replete with varying baby bottle sizes and constructions. However, none of the bottles appear to address needs that arise to collectively facilitate balance, handling, and ease of feeding infants.

While the prior art constructions may be adequate for the basic purpose and function for which they have been designed, they fail to provide a simple, efficient, and practical feeding bottle. In particular, the prior art fails to disclose a bottle sized and constructed to enhance an infant's grasp of the bottle, comfort while gripping the bottle, and increased control during the feeding process.

There is a need for an improved ergonomically designed baby bottle construction that simplifies feeding, and the support functions associated with this.

Different sipper cups are known, but these also suffer deficiencies in their utility.

It is an object of the present disclosure to provide a baby bottle and/or sipper cup to facilitate drinking, and at the same time making feeding an easier function for the feeding person.

### SUMMARY

The present disclosure recognizes and addresses disadvantages of prior art constructions and an object of the present disclosure is to provide an improved drinking device in the form of a baby bottle and/or sipper cup.

A baby drinking utensil includes a container, such as a bottle or cup, which includes an elongated side wall and a mounting of the container for receiving one or more handles on the outside of the elongated side wall for facilitating handling of the container. The handles are located at radially spaced locations circumferentially around the outside of the wall. With two handles, these are diametrically opposite each other with the elongated bottle between them. The handles are formed as an integrated substantially curved element, and the element has an aperture at one section for engagement with the mounting of the container, and the curved element essentially surrounds the container. The curved element is removable from the mounting.

In another form, the handles are formed by at least a partially embracive element. Whether curved or embracive with a different configuration, the handle is removable from the mounting of the container.

The holding or embracive device is adaptable so as to be usable as a drinking cup, commonly known as a sipper cup.

There is a rim at the top of the side wall for receiving a mouthpiece for a user, namely a nipple locating closure, or in different situations, a mouthpiece for a cup.

### DRAWINGS

The above-mentioned features and objects of the present disclosure will become more apparent with reference to the following description taken in conjunction with the accompanying drawings, wherein like reference numerals denote like elements, and in which:

FIG. 1 is a perspective view of the first embodiment.

FIG. 2 is a partially disassembled view showing the first embodiment bottle being removed from the handle.

FIG. 3 is an exploded perspective view of the components of the first embodiment.

FIG. 4 is a perspective view of the first embodiment with an alternate interface piece.

FIG. 5 is an exploded perspective view of the components of the second embodiment.

FIG. 6 is a perspective view of the second embodiment.

FIG. 7 is a side elevation view of the second embodiment with an alternate interface piece.

FIG. 8 is a front elevation view of the second embodiment with an alternate interface piece.

### DETAILED DESCRIPTION

The device is now described with reference to an example which is not to be considered as limiting. This is purely an illustration of the device.

One of ordinary skill in the art will understand that the present discussion is a description of exemplary embodiments only, and is not intended as limiting the broader aspects of the present disclosure, which broader aspects are embodied in the exemplary construction. A repeat use of reference characters in the present specification and drawings represents the same or analogous features or elements of the disclosure.

A container in the form of a baby bottle or sipper cup includes an elongated side wall and a mounting of the container for receiving more than one handle to either side of the elongated side wall for facilitating handling of the container.

There are preferably at least two handles, and the two handles are diametrically opposite each other with the elongated bottle between them. The handles are formed as an integrated substantially curved element, and the element has an aperture at one section for engagement with the mounting of the bottle or cup. The curved portion essentially surrounds the bottle or cup.

The curved element is removable from the mounting, and the mounting is located towards the top of the bottle or cup. The curved element is to either side of the bottle or cup and there is a relatively flat portion locatable towards the base of the bottle or cup. The bottle or cup fits with the handles. The base of the bottle or cup is adjacent the flat portion joining the curved elements, and the neck of the bottle constitutes at least part of the mounting and passes through the aperture in the curved element.

In some other forms, the baby bottle or cup has an elongated side wall, and a mounting for receiving a handle for facilitating handling of the bottle or cup. There can be a single handle which extends substantially from the top of the bottle or cup to a base. The handle is formed so as to be mounted at a position towards the top of the bottle or cup, namely between the bottle top and the nipple closure structure, and extend towards the base of the bottle. The handle is removable from the bottle by releasing the nipple closure structure from the bottle.

There is a rim at the top of the side wall for receiving a nipple locating closure.

The baby bottle or cup includes a lid for the bottle or cup with a neck which passes through the aperture in the handle structure such that the end of the neck extends beyond an area defined by the handle or handles.

The embracive element includes a portion locatable towards the base of the bottle or cup. The bottle or cup fits with the handles and with the base of the bottle or cup adjacent the flat portion.

The embracive element includes a side profile that is relatively narrower at a portion between the top and the bottom of the embracive element. The embracive element includes a front profile that is relatively substantially elliptical with a major axis for the element being transverse to the longitudinal axis of a bottle or cup, and with relatively flat portions at the ends of the minor axis.

The nipple locating closure is for location on the side of the mounting opposite the location of the elongated portion of the bottle. In other cases, a mouthpiece is provided in place of the nipple locating closure. The mouthpiece has an element for receiving the lips of a baby to facilitate sucking or sipping.

The lid has an aperture with an extending peripheral edge. The lid is for location with a rim at the top of the bottle, with the edge extending through a mating hole in a mounting structure forming part of the securing for the handles with the bottle. The nipple locating closure is located on the peripheral edge of the lid on the side of the mounting opposite the location of the bottle relative to the handles.

There is a cover for the nipple locating closure or mouthpiece. The cover is removable, and the cover is curved and blends with the closure. The cover is located on the side of the mounting opposite the location of the bottle relative to the handles.

The baby bottle or cup can include a concaved or convexed elongated side wall.

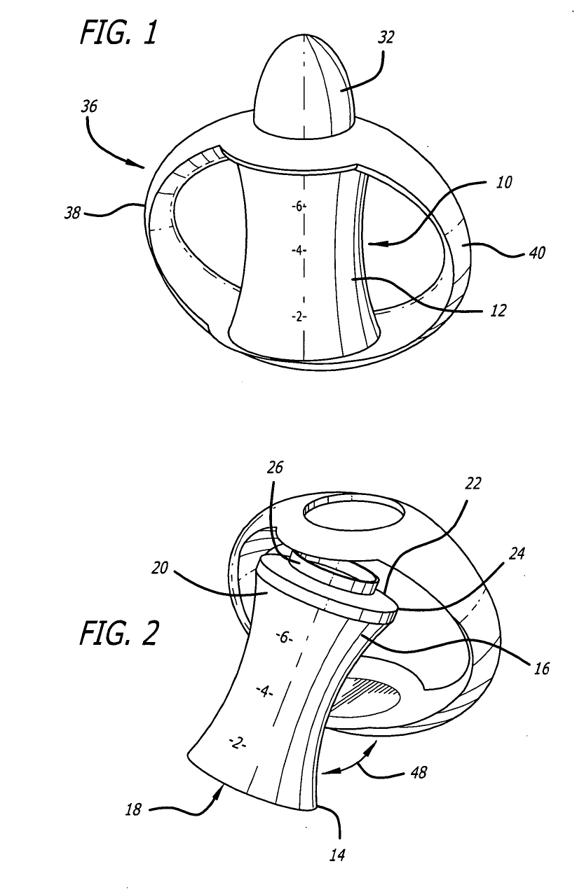

FIG. 1 shows an elongated baby bottle 10, which has a relatively concave side wall 12, in that the central portion of the side wall is less in diameter than the ends 14 and 16. The end 14 includes a flat base 18. The top includes a rim 20, which engages with a lid 22, which itself has a circumferential rim 24 for engaging with the rim 20 at the top of the bottle. The lid 22 includes a central area with an upstanding lip 26. At the top of the lip 26 there will be located a nipple holding portion 28, and the nipple 30 is located in an aperture within the nipple holding portion 28. A cover 32 is also provided and this cover 32 is for engagement about a periphery area 34 on the nipple securing portion 28.

The bottle 10 is secured in an embracing device 36, which effectively has two handles 38 and 40, which are located at either side of the bottle 10 when in place with the embracing handle device. The embracing handle device can have different shapes, and it can be circular, or, as shown in the exemplary drawings, elliptical with a major axis extending transversely relative to the longitudinal axis through the bottle 10. The minor axis is essentially longitudinal with the longitudinal axis of the bottle when located in place.

The securing device includes a base section 42 with a flat foundation 44, which seats the flat portion 18 at the bottom of the bottle 10. There is an aperture 46 in the top portion of the circular handle and the rim 26 passes through that aperture when the bottle 10 is in place. In this fashion, the bottle 10 is located firmly in place with the two handles 38 and 40 at either side of the bottle 10. The nipple retaining component 28 can be placed on the bottle on the side remote from the embracing section, and the cover can be put in place as may be needed.

As shown in FIG. 2, the arrow 48 indicates how the bottle 10 can be moved in and out of location within the embracing ring.

After the baby has become older, the handles may not be necessary and in this case, the bottle 10 can be used in a conventional manner without the two handles 38 and 40 formed by the ring 36.

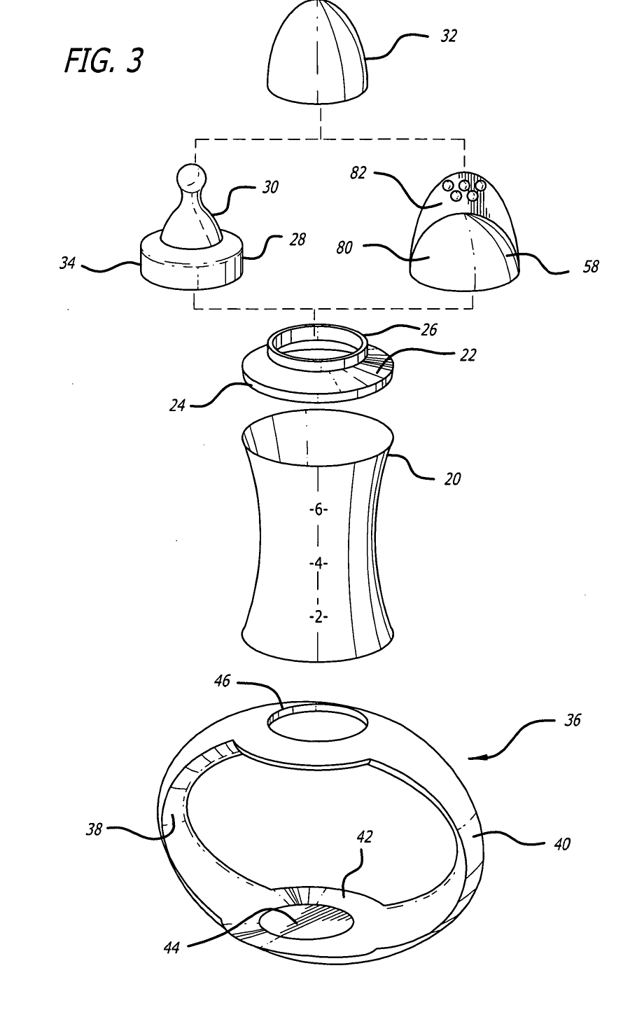

Also as shown in FIG. 3 there is a mouthpiece 58 for use with the container when it is in the form of a cup, such as a sipper cup.

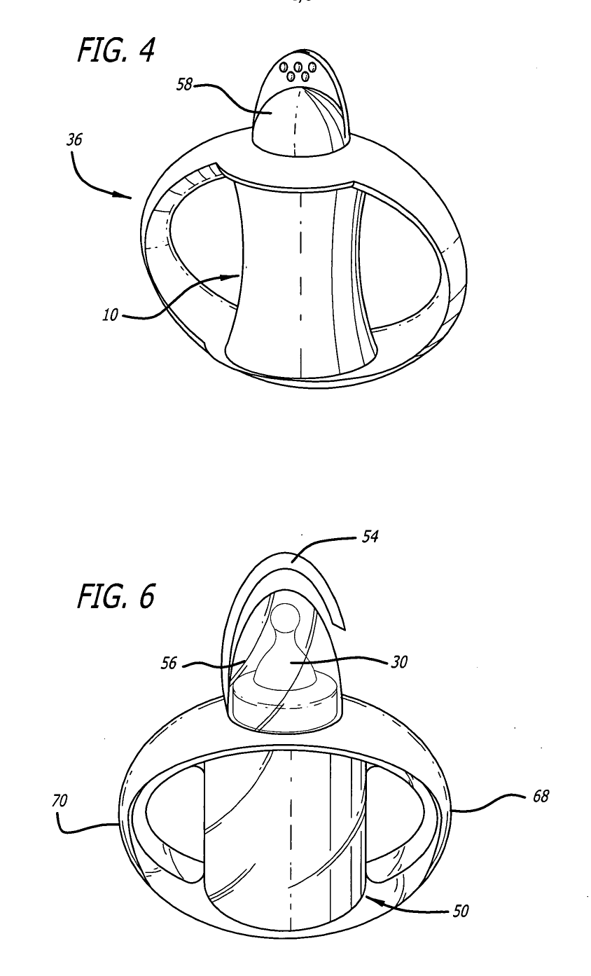

In the form of the disclosure shown in FIG. 4, the bottle 50 forms part of an internal ring 52.

As shown in FIG. 6, there is also a removable hook device 54, which extends from a cover 56, which goes over the nipple 30.

There is a rim 60, which is formed on the outside of the circle embracing handles, and the nipple 62 fits on that rim, and a securing section 64 for securing the nipple fits over the nipple and is secured to the rim 60 as necessary. The bottle 66 of this embodiment is shown with a convex configuration, at least on that side.

The handles 68 and 70 are such that their mid-portion is of a lesser width than the base 72 or the top 74.

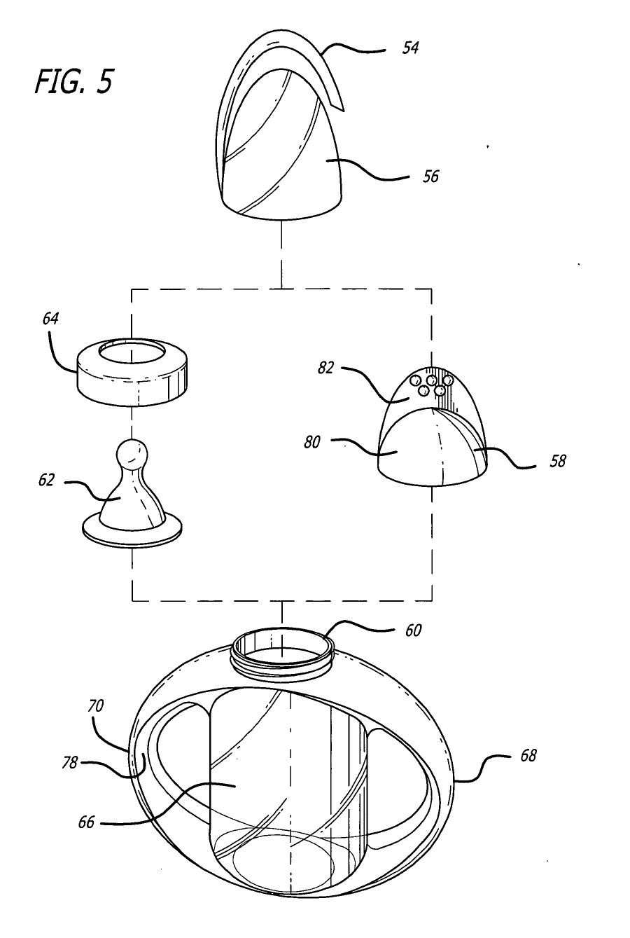

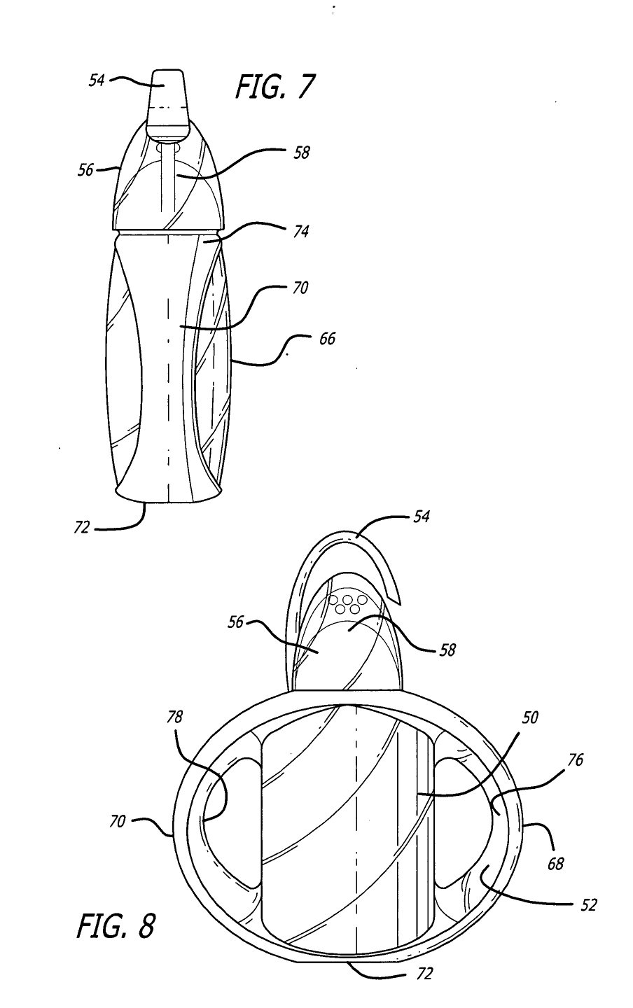

The example of FIGS. 4, 5, and 6 are such that the two-handled training bottle fits the hands of the baby. The cushioned grip facilitates handling. Standard nipples and nipple rings can be used. In other cases, there can be a no-spill, self-sip toddler spout used instead of the nipple. As such, the outlet for the bottle can be either a nipple, a mouthpiece, or a spout, as desired.

In this configuration, the bottle 50 and internal configuration rings 76 and 78, mate with the external rings 68 and 70, a configuration less intended to be separated from the handle configuration. In different configurations, the construct can be of a nature that it is not separable from that configuration.

The mouthpiece 58 is configured to have a hemispherical section 80 and a suction grip section 82 formed about the hemispherical section 80. The suction section 82 is formed for securing the lips of a baby.

The cylindrical top portion and the body may be molded of a suitable plastic material, which may be blow molded, by extrusion or injection, so that it is a unitary member of uniform wall thickness. A suitable transparent plastic for forming the bottle includes, but is not limited to, polystyrene, polystyrene-acrylonitile, acrylonitile-butadiene-styrene, styrene-maleicanhydride, polycarbonate, polyethylene terephthalate, polyvinylcyclohexane, and blends thereof.

The baby bottle can be formed from any desired conventional material such as glass or plastic. The bottle preferably has a generally circular, but not essentially, cross-sectional area. Thus, for instance, it can be rectangular or other desired shape which can be curved to a greater or lesser extent. The bottle side wall can be straight, curved in part, or whole, and have grip formations for fingers if desired. More than two handles can be provided. Instead of being at 180° radial spacing, the spacing may be less than 180°, for instance 90° or 120°.

While the device and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A fluid container comprises an elongated side wall, a mounting of the container for receiving a handle on at least two sides of the elongated side wall for facilitating handling of the container, and a rim at the top of the side wall for receiving a mouthpiece locating closure for securing a mouthpiece for a user.

2. A fluid container for a container or cup comprising an elongated side wall, a mounting of the container for receiving at least two handles for facilitating handling of the container, the handles being located at radially spaced positions circumferentially around the outside of the wall of the container, a rim at the top of the side wall for receiving a locating closure for a mouthpiece for a user, and wherein the two handles are diametrically opposite each other with the elongated container between them.

3. The container of claim 2, wherein the at least two handles are formed as an integrated unit.

4. The container of claim 1, wherein the container includes a concaved elongated side wall.

5. A container comprising an elongated side wall, a mounting for receiving at least two handles for facilitating handling of the container, a rim at the top of the side wall for receiving a nipple locating closure, and the handles being formed as an integrated substantially curved element, the element having an aperture at one section for engagement with the mounting of the container, and the curved portion essentially surrounding the container.

6. The container of claim 5, wherein the curved element is removable from the mounting, and the curved elements joining in a relatively flat portion locatable towards the base of the container, such that the container is for fitting inside the handles with the base of the container adjacent the flat portion and the neck of the container passing through the aperture in the curved element.

7. The container of claim 6, including a lid for the container with a neck for passing through the aperture such that the end of the neck is beyond an area defined by the handles.

8. The container of claim 1, wherein the handles are formed by at least a partially embracive element which is removable from the mounting, the mounting being towards the top of the container.

9. The container of claim 8, wherein the embracive element includes a portion locatable towards the base of the container, such that the container is for fitting with the handles and with the base of the container adjacent the flat portion.

10. The container of claim 8, wherein the embracive element includes a side profile that is relatively narrower at a portion between the top and the bottom of the embracive element.

11. The container of claim 8, wherein the embracive element includes a front profile that is relatively substantially elliptical with a major axis for the element being transverse to the longitudinal axis of a container, and with relatively flat portions at the ends of the minor axis.

12. The container of claim 1, wherein the mouthpiece locating closure is for location on the side of the mounting, opposite the location of the elongated portion of the container.

13. The container of claim 1, including a lid for the container, the lid having an aperture with an extending peripheral edge, the lid being for location with a rim at the top of the container with the edge extending through a mating hole in a mounting structure forming part of the securing for the handles with the container, and wherein the mouthpiece locating closure is for location on the peripheral edge of the lid on the side of the mounting opposite the location of the container relative to the handles.

14. The container of claim 1, including a cover for the mouthpiece locating closure, the cover being removable, and wherein the cover is curved and blends with closure and the cover is for location on the side of the mounting opposite the location of the container relative to the handles.

15. The container of claim 13, including a cover for the mouthpiece locating closure, the cover being removable, and wherein the cover is curved and blends with closure and the cover is for location on the side of the mounting opposite the location of the container relative to the handles.

16. A container comprising an elongated side wall, a mounting for receiving more than one handle on the outside of the elongated side wall for facilitating handling of the container, and a rim at the top of the side wall for receiving a mouthpiece locating closure.

17. A container comprising an elongated side wall, a mounting for receiving a handle for facilitating handling of the container, a rim at the top of the side wall for receiving a mouthpiece locating closure, the handle extending substantially from the top of the container to a base, the handle being formed so as to be mounted towards the top of the container between the container top and the mouthpiece closure structure and being directed towards the base of the container, and the handle being removable from the container by releasing the mouthpiece closure structure from the container.

18. The container of claim 17, including a partly embracive element to form a handle, and including a portion locatable towards the base of the container, such that the container and handle fit together, the fit being with the embracive element in engagement with a flat portion of the base of the container.

19. The container of claim 17, including a partly embracive element to form a pair of handles, and including a portion of the embracive element locatable towards the base of the container, such that the container and handle fit together, the fit being with the embracive element in engagement with a flat portion of the base of the container.

20. The container of claim 17, wherein the embracive element includes a side profile that is relatively narrower at a portion between the top and the bottom of the embracive element.

21. The container of claim 17, wherein the embracive element includes a front profile that is relatively substantially elliptical with a major axis for the element being transverse to the longitudinal axis of a container, and with relatively flat portions at the ends of a minor axis.

22. The container of claim 17, wherein the nipple locating closure is for location on the side of the mounting opposite the location of the elongated portion of the container.

23. The container of claim 17, including a lid for the container, the lid having an aperture with an extending peripheral edge, the lid being for location with a rim at the top of the container with the edge extending through a mating hole in a mounting structure forming part of the securing for the handles with the container, and the nipple locating closure being for location on the peripheral edge of the lid on the side of the mounting opposite the location of the container relative to the handle.

24. The container of claim 17, including a cover for the mouthpiece locating closure, the cover being removable, the cover being curved and blending with the closure and the cover being for location on the side of the mounting opposite the location of the container relative to the handle.

25. The container of claim 17, including a cover for the mouthpiece locating closure, the cover being removable, the cover being curved and blending with the closure, and the cover being for location on the side of the mounting opposite the location of the container relative to the handle.

26. The container of claim 19, wherein the pair of handles form an integrated unit.
